(19) United States
(12) Patent Application Publication
(10) Pub. No.: US 2026/0108952 A1
(43) Pub. Date: Apr. 23, 2026

(54) SURFACE COATED CUTTING TOOLS

(71) Applicant: KENNAMETAL INC., Latrobe, PA (US)

(72) Inventor: Kimaya Vyavhare, Latrobe, PA (US)

(21) Appl. No.: 18/918,635

(22) Filed: Oct. 17, 2024

(51) Int. Cl. B23B 27/14

(52) U.S. Cl. CPC B23B 27/148; B23B 2224/04; B23B 2224/32; B23B 2228/04; B23B 2228/105; B23B 2228/24; B23B 2228/36; B23B 2228/44

(57) ABSTRACT

In one aspect, cutting tools are described herein comprising refractory coatings comprising MT-TiCN and α-Al₂O₃ layers having crystallographic orientations and architectures advantageous for resisting various degradative mechanisms including cracking and/or flaking. Accordingly, cutting tools having such refractory coatings, in some embodiments, are suitable for high wear and/or abrasion applications, such as metal cutting operations.

### FIELD

The present invention relates to refractory coatings and, in particular, to refractory coatings deposited by chemical vapor deposition (CVD) for cutting tool and/or metal removal applications.

### BACKGROUND

Cutting tools, including cemented carbide cutting tools, have been used in both coated and uncoated conditions for machining various metals and alloys. In order to increase cutting tool wear resistance, performance and lifetime, one or more layers of refractory material have been applied to cutting tool surfaces. TiC, TiCN, TiN and/or Al₂O₃, for example, have been applied to cemented carbide substrates by CVD and by physical vapor deposition (PVD). While effective in inhibiting wear and extending tool lifetime in a variety of applications, refractory coatings based on single or multi-layer constructions of the foregoing refractory materials have increasingly reached their performance limits, thereby calling for the development of new coating architectures for cutting tools.

### SUMMARY

In one aspect, cutting tools are described herein comprising wear resistant coatings employing crystallographic engineered layers of medium temperature (MT) TiCN and α-Al₂O₃. In some embodiments, a coated cutting tool comprises a substrate, and a multilayered coating adhered to the substrate comprising a layer of medium temperature (MT) TiCN deposited by chemical vapor deposition (CVD), wherein the MT-TiCN layer comprises columnar grains having inclinations 0° to 10° between a normal line of a (112) crystal plane and a normal line to the substrate occupying at least 35 percent of a polished cross-sectional area of the MT-TiCN layer as determined by electron backscatter diffraction (EBSD); and a layer of α-Al₂O₃ deposited by CVD over the MT-TiCN layer, the α-Al₂O₃ layer comprising columnar grains having inclinations of 0° to 10° between a normal line of a (0001) crystal plane and a normal line to the substrate occupying 35-65 percent of a polished cross-sectional area of the α-Al₂O₃ layer as determined by EBSD.

In some embodiments, the MT-TiCN layer has a texture coefficient (TC) of 2.5-3.5 for the (311) growth direction, the TC(311) being defined as:

$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$

where
I(hkl)=measured intensity of the (hkl) reflection;
Iₒ(hkl)=standard intensity of the (hkl) reflection according to International Center for
Diffraction Data (ICDD) card 43-1484;
n=number of reflections (7) used in the TC calculation
(hkl) reflections used in the TC calculation are (111) (200) (220) (311) (331) (420) (422).

Moreover, in some embodiments, the α-Al₂O₃ layer has texture coefficients greater than 7 for the (006) growth direction and greater than 5 for the (0 0 12) growth direction, the texture coefficients being defined as:

$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$

where
I(hkl)=measured intensity of the (hkl) reflection
I₀ (hkl)=standard intensity of the (hkl) reflection according to International Center for Diffraction Data (ICDD) card 43-1484
n=number of reflections (7) used in the TC calculation
(hkl) reflections used in the TC calculation are:
(012), (104), (110), (006), (113), (202), (024) and (116) to calculate TC(006); and
(012), (104), (110), (113), (116), (300), (214) and (0 0 12) to calculate TC(0012).

In another aspect, methods of making coated cutting tools are described herein. In some embodiments, a method comprises providing a substrate, and depositing a layer of MT-TiCN by CVD over the substrate, wherein the MT-TiCN layer comprises columnar grains having inclinations of 0° to 10° between a normal line of a (112) crystal plane and a normal line to the substrate occupying at least 35 percent of a polished cross-sectional area of the MT-TiCN layer as determined by EBSD. A layer of α-Al₂O₃ is deposited over the MT-TiCN layer by CVD, wherein the α-Al₂O₃ comprises columnar grains having inclinations of 0° to 10° between a normal line of a (0001) crystal plane and a normal line to the substrate occupying 35-65 percent of a polished cross-sectional area of the α-Al₂O₃ layer as determined by EBSD. As described further herein, the α-Al₂O₃ is nucleated on a TiOCN layer adjacent to the MT-TiCN layer.

These and other embodiments are further described in the following detailed description.

### BRIEF DESCRIPTION OF THE DRAWINGS

FIG. 1A is a top down scanning electron micrograph (SEM) image of a MT-TiCN layer according to one embodiment of the present invention illustrating the fine grain structure.

FIG. 1B is a top down SEM of a prior MT-TiCN layer.

FIG. 2 illustrates metal cutting results of a grooving insert employing a multilayer coating described herein relative to a comparative grooving insert having a prior multilayer coating.

FIG. 3A illustrates wear of a grooving insert employing a multilayer coating described herein.

FIG. 3B illustrates wear of a comparative grooving insert employing a prior multilayer coating.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In one aspect, cutting tools are described herein comprising refractory coatings comprising MT-TiCN and α-Al₂O₃ layers having crystallographic orientations and architectures advantageous for resisting various degradative mechanisms including cracking and/or flaking. Accordingly, cutting tools having such refractory coatings, in some embodiments, are suitable for high wear and/or abrasion applications, such as metal cutting operations. Turning now to specific components, a coated article comprises a substrate. A coated article can comprise any substrate not inconsistent with the objectives of the present invention. For example, a substrate can be a cutting tool or tooling used in wear applications. Cutting tools include, but are not limited to, cutting inserts (indexable and non-indexable), end mills, drills, and other round tools. Indexable cutting inserts can have any desired ANSI standard geometry for milling or turning applications. Substrates of coated articles described herein can be formed of cemented carbide, carbide, ceramic, cermet, steel or other alloy. A cemented carbide substrate, in some embodiments, comprises tungsten carbide (WC). WC can be present in a cutting tool substrate in an amount of at least about 80 weight percent or in an amount of at least about 85 weight percent. Additionally, metallic binder of cemented carbide can comprise cobalt or cobalt alloy. Cobalt, for example, can be present in a cemented carbide substrate in an amount ranging from 1 weight percent to 15 weight percent. In some embodiments, cobalt is present in a cemented carbide substrate in an amount ranging from 5-12 weight percent or from 6-10 weight percent. Further, a cemented carbide substrate may exhibit a zone of binder enrichment beginning at and extending inwardly from the surface of the substrate.

Cemented carbide substrates can also comprise one or more additives such as, for example, one or more of the following elements and/or their compounds: titanium, niobium, vanadium, tantalum, chromium, zirconium and/or hafnium. In some embodiments, titanium, niobium, vanadium, tantalum, chromium, zirconium and/or hafnium form solid solution carbides with WC of the substrate. In such embodiments, the substrate can comprise one or more solid solution carbides in an amount ranging from 0.1-5 weight percent. Additionally, a cemented carbide substrate can comprise nitrogen.

As described above, the coating adhered to the substrate comprises a layer of MT-TiCN deposited by CVD, wherein the MT-TiCN layer comprises columnar grains having inclinations of 0° to 10° between a normal line of a (112) crystal plane and a normal line to the substrate occupying at least 35 area percent of a polished cross-sectional area of the MT-TiCN layer as determined by EBSD. In some embodiments, the columnar grains of the MT-TiCN layer having inclinations of 0° to 10° occupy 35-60 percent or 40-60 percent of the polished cross-sectional area. Columnar grains of the MT-TiCN layer having inclinations of 0° to 10° occupying 35-60 percent or 40-60 percent of the polished cross-sectional area can reside on flank face, rake face or both rake and flank faces of the cutting tool.

The MT-TiCN layer can have a thickness of 2 μm to 20 μm, in some embodiments. Thickness of the MT-TiCN coating can be selected according to various considerations including identity of the substrate, thickness of the α-Al₂O₃ layer, and/or overall desired thickness of the multilayer coating. In some embodiments, the MT-TiCN layer has a thickness of 2 μm to 8 μm or 2 μm to 4 μm.

In addition to the foregoing crystallographic inclinations, the MT-TiCN layer, in some embodiments, can have a texture coefficient (TC) of 2.5-3.5 for the (311) growth direction, the TC(311) being defined as:

$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$

where
I(hkl)=measured intensity of the (hkl) reflection;
Iₒ(hkl)=standard intensity of the (hkl) reflection according to International Center for
Diffraction Data (ICDD) card 43-1484;
n=number of reflections (7) used in the TC calculation
(hkl) reflections used in the TC calculation are (111) (200) (220) (311) (331) (420) (422).

The MT-TiCN layer can also exhibit 23 type grain boundaries between adjacent TiCN grains. In some embodiments, the MT-TiCN layer has a length of 23 type of grain boundaries as measured using EBSD more 20% and less than 40% of the total length of all grain boundaries. In some embodiments, the 23 type of grain boundaries are 25-35% of the total length of all grain boundaries.

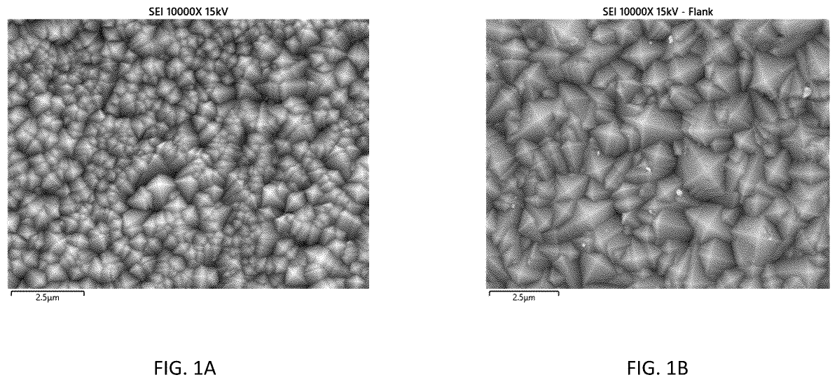

In some embodiments, the MT-TiCN layer has a hardness of at least 24 GPa. The MT-TiCN layer, for example, can have a hardness of 24-30 GPa. Additionally, the MT-TiCN layer, in some embodiments, has a hardness (H) to modulus (E) ratio of 0.043-0.05. Hardness and modulus of the TiCN layer is determined by nanoindentation. The MT-TiCN layer can exhibit a fine grain structure relative to prior MT-TiCN layers. FIG. 1A is a top down scanning electron micrograph (SEM) image of a MT-TiCN layer according to one embodiment of the present invention illustrating the fine grain structure. FIG. 1B is a top down SEM of a prior MT-TiCN layer.

It has been found that a MT-TiCN layer having the foregoing crystallographic properties is advantageous in assisting nucleation of an α-Al₂O₃ layer having the following properties. As described herein, a TiOCN nucleation layer can extend form the MT-TiCN layer.

The multilayer coating also comprises a layer of α-Al₂O₃ deposited by CVD over the MT-TiCN layer, the α-Al₂O₃ layer comprising columnar grains having inclinations of 0° to 10° between a normal line of a (0001) crystal plane and a normal line to the substrate occupying 35-65 percent area of a polished cross-sectional area of the α-Al₂O₃ layer as determined by EBSD. In some embodiments, the α-Al₂O₃ layer has texture coefficients greater than 7 for the (006) growth direction and greater than 5 for the (0 0 12) growth direction, the texture coefficients being defined as:

$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$

where
I(hkl)=measured intensity of the (hkl) reflection
Iₒ(hkl)=standard intensity of the (hkl) reflection according to International Center for
Diffraction Data (ICDD) card 43-1484
n=number of reflections (7) used in the TC calculation
(hkl) reflections used in the TC calculation are:
(012), (104), (110), (006), (113), (202), (024) and (116) to calculate TC(006); and
(012), (104), (110), (113), (116), (300), (214) and (0 0 12) to calculate TC(0012).

In some embodiments, the TC is from 7-7.8 for the (006) growth direction and the TC is from 6.5-7.6 for the (0 0 12) growth direction.

XRD peak data for calculations of the texture coefficients (TC) for the MT-TiCN layer and the α-Al₂O₃ layer are measured on the as-coated top rake face of the cutting tool, such as a cutting insert, using a Bragg focusing diffractometer.

### Incidence Optics Included:

Long fine focus X-ray tube operating at 45 KV and 40 MA.

Variable divergence optic operating in automatic mode to insure constant irradiated sample volume throughout the analysis.

Fixed antiscatter slit

### Receiving Optics Included:

Variable Antiscatter slit operating in automatic mode to match the automatic divergence slit Multistrip solid state detector operating in scanning mode.

Scan parameters (speed and count time) are selected to insure a minimum of ten data steps across the peak full width at half max (FWHM) and approximately 10,000 total counts on the most intense peak. Collected data is first converted from variable mode to fixed mode usable for analysis. This conversion is completed using the formula:

$${I}_{FIX} ( θ , a ) = {I}_{A D S} ( θ , L ) \times ( \frac{R sin ( a / 2 )}{L} ) \times ( \frac{1}{sin ( θ + a / 2 )} + \frac{1}{sin ( θ - a / 2 )} )$$

where a=the divergence angle and L=the irradiated length on the sample

The corrected intensity is analyzed using peak finding software to identify the peak position of all peaks in the collected data. The peaks are then refined using a profile function to precisely identify the peak position and peak height. This peak data is used for the alumina texture coefficient analysis. Due to the complexity of the CVD coating architecture, a thickness correction for the peak intensity was not applied.

Grains of the polycrystalline α-Al₂O₃ layer, in some embodiments, can exhibit a columnar morphology with the long axis normal or substantially normal to the substrate. The columnar grains, in some embodiments, can exhibit an average grain width less than 5 μm. Average grain width, in some embodiments, is less than 3 μm, such as 0.5 μm to 2.5 μm. In some embodiments, average grain width is 0.5-4.5 μm or 1-3 μm. Average grain width is an average of the width of 25 consecutive grains of the polycrystalline α-Al₂O₃ layer measured on the polished cross-section of the polycrystalline α-Al₂O₃ layer using band contrast EBSD imaging. Alumina grain width was determined by using the caliper function on the EBSD band contrast maps in the data collection software. Measurements were taken from approximately 20 adjacent grains in the center of the coating layer. The measurements from the caliper function are based on the SEM magnification and internal calibrations in the software.

Crystallographic inclinations and 23 type boundaries of the grains in the MT-TiCN layer and the α-Al₂O₃ layer described herein are determined with EBSD as follows. In crystalline materials, the orientation of a crystallite is defined by a transformation from a sample reference frame (i.e. defined by the direction of a rolling or extrusion process and two orthogonal directions) to the local reference frame of the crystalline lattice, as defined by the basis of the unit cell. In the same way, misorientation is the transformation necessary to move from one local crystal frame to some other crystal frame. That is, it is the distance in orientation space between two distinct orientations. If the orientations are specified in terms of matrices of direction cosines gA and gB, then the misorientation operator AgAB going from A to B can be defined as follows:

$$\begin{matrix}{g}_{B} = Δ {g}_{AB} {g}_{A} \\ Δ {g}_{AB} = {g}_{B} {g}_{A}^{- 1}\end{matrix}$$

where the term g⁻¹ A is the reverse operation of gA, that is, transformation from crystal frame A back to the sample frame. This provides an alternate description of misorientation as the successive operation of transforming from the first crystal frame (A) back to the sample frame and subsequently to the new crystal frame (B).

Various methods can be used to represent this transformation operation, such as: Euler angles, Rodrigues vectors, axis/angle (where the axis is specified as a crystallographic direction), or unit quaternions. EBSD is well suited to extract this type of information as it gives both statistical and spatial information about the grain boundaries. The pattern consists of straight bright bands, so called Kikuchi bands, which have a direct relation to the lattice planes of the diffracting crystal: the centre line of each of the bands directly corresponds to the gnomonic projection of the lattice planes. The width of the Kikuchi band is approximately proportional to the Bragg angle of electron diffraction on the related lattice plane. The band intensity profile corresponds to the dynamic electron diffraction intensity obtained in a rocking experiment across the related lattice plane.

From the geometry of the Kikuchi bands in the pattern, the crystallographic phase and orientation can be determined. The band profiles contain information on the local defect densities (in particular on dislocation densities). This information can be obtained in a highly automated manner by computer software which then displays the basis of so called EBSD-based orientation microscopy (ORM).

Columnar grain inclinations and 23 type grain boundary data in the polycrystalline MT-TiCN and α-Al₂O₃ layer described herein can be determined according to the following protocol. A cross-sectional area of the coated tool is polished to a mirror finish. Colloidal silica is a suitable polishing agent, although diamond paste, ion milling, and other methods are acceptable. The prepared surface is observed using a field-emission scanning electron microscope (FESEM) and an electron backscatter diffraction (EBSD) detector. With the FESEM, an electron beam at an acceleration voltage of 25 kV irradiated the polished surface, which was inclined to 70° with respect to the incident electron beam, to measure orientation angles of the hexagonal alumina crystal grains based on the collected Kikuchi diffraction patterns. Data is collected from an area of approximately 20 μm×80 μm, with a step size of 0.1 μm. Data processing is done using a commercially available software for the FESEM/EBSD apparatus to determine a misorientation angle. An average over 3 EBSD maps is taken to arrive at the inclination values and 23 type boundary values. The 3 EBSD maps can be measured on the flank face or rake face of the cutting tool, in some embodiments.

Further, the α-Al₂O₃ layer can exhibit low residual tensile stress in the as-deposited state. In some embodiments, the alumina phase has a residual tensile stress of 100-500 MPa or 20-400 MPa in the as-deposited state. Residual stress of the alumina phase can be determined using the Chi tilt Sin² ψ method with reference to the (116) reflection. For the alumina phase analysis, Poisson's Ratio (ν) was set to 0.19, and the clastic modulus (E in GPa) was determined to be 415 from analysis of a single phase α-alumina coating by nanoindentation hardness. Additionally, the polycrystalline α-Al₂O₃ layer can have any desired thickness. In some embodiments, the polycrystalline α-Al₂O₃ layer has a thickness of 1-20 μm or 5-15 μm.

The α-Al₂O₃ layer can have any desired thickness. In some embodiments, the α-Al₂O₃ layer has a thickness of 1 μm to 10 μm or 2 μm to 6 μm. The α-Al₂O₃ layer, in some embodiments, has a thickness of 1 μm to 6 μm or 1.5μ m to 4 μm, or 2μ m to 3μ m.

The α-Al₂O₃ layer can be the outermost layer of the coating. Alternatively, a coating described herein can comprise one or more outer layers over the α-Al₂O₃ layer. Outer layer(s) can comprise one or more metallic elements selected from the group consisting of aluminum and metallic elements of Groups IVB, VB and VIB of the Periodic Table and one or more non-metallic elements selected from Groups IIIA, IVA, VA and VIA of the Periodic Table. Outer layer(s) over the α-Al₂O₃ layer can comprise a carbide, nitride, carbonitride, oxycarbonitride, oxide or boride of one or more metallic elements selected from the group consisting of aluminum and metallic elements of Groups IVB, VB and VIB of the Periodic Table. For example, one or more outer layers are selected from the group consisting of titanium nitride, titanium carbonitride, titanium oxycarbonitride, titanium carbide, zirconium nitride, zirconium carbonitride, hafnium nitride, hafnium carbonitride, alumina, TiAlₓSi_{y}CᵥN, aluminum oxynitride, and combinations thereof.

Outer layers of coatings described herein can have any thickness not inconsistent with the objectives of the present invention. A coating outer layer, in some embodiments, can have a thickness ranging from 0.2 μm to 5 μm.

Coatings described herein can be subjected to post-coat treatments. Coatings, for example, can be blasted with various wet and/or dry particle compositions. Post coat blasting can be administered in any desired manner. In some embodiments, post coat blasting comprises shot blasting or pressure blasting. Pressure blasting can be administered in a variety of forms including compressed air blasting, wet compressed air blasting, pressurized liquid blasting, wet blasting and steam blasting. Wet blasting, for example, is accomplished using a slurry of inorganic and/or ceramic particles, such as alumina, and water. The particle slurry can be pneumatically projected at a surface of the coated cutting tool body to impinge on the surface of the coating. The inorganic and/or ceramic particles can generally range in size between about 20 μm and about 100 μm.

Blasting parameters include pressure, angle of impingement, distance to the part surface and duration. In some embodiments, angle of impingement can range from about 10 degrees to about 90 degrees, i.e., the particles impinge the coating surface at an angle ranging from about 10 degrees to about 90 degrees. Suitable pressures can range from 30-55 pounds per square inch (psi) at a distance to the coated surface of 1-6 inches. Further, duration of the blasting can generally range from 1-10 seconds or longer. Blasting can be generally administered over the surface area of the coating or can be applied to select locations such as in a workpiece contact area of the cutting tool. A workpiece contact area can be a honed region of the cutting tool.

In other embodiments, a coating is subjected to a polishing post-coat treatment. Polishing can be administered with paste of appropriate diamond or ceramic grit size. Grit size of the paste, in some embodiments, ranges from 1 μm to 10 μm. In one embodiment, a 5-10 μm diamond grit paste is used to polish the coating. Further, grit paste can be applied to the CVD coating by any apparatus not inconsistent with the objectives of the present invention, such as brushes. In one embodiment, for example, a flat brush is used to apply grit paste to the CVD coating in a workpiece contact area of the cutting tool.

A coating described herein can be blasted or polished for a time period sufficient to achieve a desired surface roughness (Rₐ) and/or other parameters such as reducing residual tensile stress in the coating. In some embodiments, a coating subjected to post-coat treatment has a surface roughness (Rₐ) selected from Table I.

TABLE I
Post-Coat Surface Roughness (Rₐ)
Coating Surface Roughness (Rₐ) - nm

≤500
≤250
<200
10-250
50-175
25-150

Coating surface roughness can be determined by optical profilometry using WYKOR NT-Series Optical Profilers commercially available from Veeco Instruments, Inc. of Plainview, New York. Coating surface roughness can be determined via optical metrology with instrumentation commercially available from Bruker Alicona of Itasca, IL.

Further, a post-coat treatment, in some embodiments, does not remove one or more outer layers of the coating. In some embodiments, for example, a post-coat treatment does not remove an outer layer of TiN, TiCN and/or TiOCN. Alternatively, a post-coat treatment can remove or partially remove one or more outer layers, such as TIN, TiCN and TiOCN to expose the underlying polycrystalline α-Al₂O₃ layer.

In another aspect, methods of making coating cutting tools are described herein. In some embodiments, a method comprises providing a substrate, and depositing a layer of MT-TiCN by CVD over the substrate, wherein the MT-TiCN layer comprises columnar grains having inclinations of 0° to 10° between a normal line of a (112) crystal plane and a normal line to the substrate occupying at least 35 percent of a polished cross-sectional area of the MT-TiCN layer as determined by EBSD. A layer of α-Al₂O₃ is deposited over the MT-TiCN layer by CVD, wherein the α-Al₂O₃ comprises columnar grains having inclinations of 0° to 10° between a normal line of a (0001) crystal plane and a normal line to the substrate occupying 35-65 percent of a polished cross-sectional area of the α-Al₂O₃ layer as determined by EBSD. As described further herein, the α-Al₂O₃ is nucleated on a TiOCN layer adjacent to the MT-TiCN layer. The MT-TiCN and α-Al₂O₃ layers can have any structure or properties described herein above.

These and other embodiments are further illustrated in the following non-limiting examples.

### Example 1—Coated Cutting Tools

Sintered cemented carbide grooving inserts of geometry A4G0505M05U08GMN were provided having the composition of Table II.

TABLE II
Sintered Cemented Carbide Substrate Composition

| Component | Weight Percent |
|---|---|
| Cobalt | 6.5-7.5 |
| Group IV-VI Carbides | 5-7 |
| WC | Balance |

The sintered cemented carbide grooving inserts were provided a multilayer CVD coating having the composition and architecture provided in Table III.

TABLE III
CVD Coating Architecture

| Layer | Thickness (μm) |
|---|---|
| TiN* | 0.2-0.8 |
| MT-TiCN | 3.5-6.5 |
| TiOₓC_{y}N_{z} | 0.5-1.0 |
| α-Al₂O₃ layer | 2.5-5.5 |
| Outer TiCN/TiN† | 0.5-1.5 |

*Base layer adjacent to the substrate
†This layer removed from the rake face via blasting

The coatings were deposited in a Sucotec CVD furnace commercially available from Oerlikon Balzers. The coatings were deposited according to the parameters of Tables IV and V. For enhanced adhesion, a bonding layer including HT-TiCN and TiOCN is adjacent to the Al₂O₃ layer.

TABLE IV
CVD Deposition of Coating Layers

| | H₂ | N₂ | TiCl₄ | CH₃CN | CH₄ | AlCl₃ | CO₂ | CO | HCl | H₂S |
|---|---|---|---|---|---|---|---|---|---|---|
| Process Step | vol. % | vol. % | vol. % | vol. % | vol. % | vol. % | vol. % | vol. % | vol. % | vol. % |
| TiN | Bal. | 36- | 0.007- | — | — | — | — | — | — | — |
| | | 38 | 0.010 | | | | | | | |
| MT-TiCN | Bal. | 16- | 0.010- | 0.001- | — | — | — | 0.85 | — | — |
| | | 18 | 0.015 | 0.002 | | | | | | |
| HT-TiCN | Bal. | 28- | 0.008- | — | 4.3- | — | — | — | — | — |
| | | 30 | 0.011 | | 4.5 | | | | | |
| TiOCN | Bal. | 34- | 0.009- | — | 1.8- | — | — | 1.3- | 1.6- | — |
| | | 37 | 0.012 | | 2.3 | | | 1.4 | 1.7 | |
| TiAlOCN | Bal. | 35- | 0.012- | 0.001- | — | 0.55- | — | 4.3- | — | — |
| | | 38 | 0.015 | 0.003 | | 0.65 | | 4.5 | | |
| Al₂O₃ | Bal. | — | — | — | — | 2.0- | 4.25- | 2.3- | 1.9- | 0.6- |
| | | | | | | 2.3 | 4.35 | 2.5 | 2.0 | 0.7 |
| Outer TiCN | Bal. | 28- | 0.008- | — | 4.3- | — | — | — | — | — |
| | | 30 | 0.011 | | 4.5 | | | | | |
| Outer TiN | Bal. | 40- | 0.011- | — | — | — | — | — | — | — |
| | | 43 | 0.015 | | | | | | | |

TABLE V
CVD Deposition Steps

| | Temperature | Pressure | Time |
|---|---|---|---|
| Process Step | ° C. | mbar | min. |
| TiN | 800-900 | 300-600 | 30-150 |
| MT-TiCN | 800-900 | 70-100 | 150-300 |
| HT-TiCN | 950-1050 | 350-420 | 5-70 |
| TiAlCNO | 950-1050 | 60-100 | 5-70 |
| Al₂O₃ | 950-1050 | 50-120 | 150-350 |
| Outer TiCN | 900-1050 | 650-750 | 15-30 |
| Outer TiN | 900-1050 | 650-750 | 15-120 |

The rake faces of the coated inserts were blasted with slurry as described hereinabove to remove the outer TiCN/TiN layer and expose the underlying α-Al₂O₃ layer. Nine of the blasted inserts were chosen for texture evaluation and characterization of columnar grain inclinations of the MT-TiCN and α-Al₂O₃ layers. The results of the characterization are provided in Table VI and Table VII. A Comparative coated grooving insert was also provided. The Comparative Sample employed a CVD coating architecture having parameters consistent with Table III above. Notably, as set forth in Tables VI and VII, the Comparative Sample did not employ MT-TiCN and α-Al₂O₃ layers having the textural and crystallographic properties described herein.

TABLE VI
Texture Coefficients of Coated Grooving Inserts

| Grooving | α-Al₂O₃ | α-Al₂O₃ | TiCN |
|---|---|---|---|
| Insert | (006) | (0 0 12) | (311) |
| 1 | 7.46 | 7.29 | 2.65 |
| 2 | 7.34 | 7.06 | 2.81 |
| 3 | 7.40 | 7.15 | 2.68 |
| 4 | 7.41 | 7.22 | 3.22 |
| 5 | 7.32 | 6.91 | 3.09 |
| 6 | 7.44 | 7.14 | 3.36 |
| 7 | 7.65 | 7.54 | 2.94 |
| 8 | 7.35 | 6.96 | 2.78 |
| 9 | 7.6 | 7.45 | 2.82 |
| Comparative Sample | 1.4 | 0.32 | 2.75 |

TABLE VII
Crystallographic Inclinations

| | % Grains of α-Al₂O₃ | % Grains of MT-TiCN |
|---|---|---|
| Grooving Insert | within 10° of (0001) | within 10° of (112) |
| 1 | 50.9 (F); 56.4 (R) | 43.0 (F); 42.1 (R) |
| 2 | 46.2 (F); 47.9 (R) | 41.6 (F); 33.0 (R) |
| 3 | 59.1 (F); 51.2 (R) | 50.8 (F); 43.0 (R) |
| 4 | 59.6 (F); 59.0 (R) | 45.8 (F); 44.1 (R) |
| 5 | 46.0 (F); 42.3 (R) | 43.4 (F); 39.0 (R) |
| 6 | 43.9 (F); 48.2 (R) | 39.4 (F); 39.3 (R) |
| 7 | 60.9 (F); 55.7 (R) | 52.1 (F); 41.7 (R) |
| 8 | 46.3 (F); 52.0 (R) | 43.4 (F); 44.8 (R) |
| 9 | 51.6 (F); 62.5 (R) | 47.7 (F); 42.7 (R) |
| Comparative Sample | 0 (F); 0 (R) | 27.1 (F); 30.5 (R) |

F = flank;
R = rake

Grooving insert #5 was chosen for metal cutting testing relative to the Comparative Sample. Parameters of the grooving test were:
Workpiece: 4041 Steel
Speed: 750 sfm
Feed Rate: 0.008 ipr
Depth of Cut: 0.1 mm
Coolant: flood
Groove width: 0.199
Wall Width: 0.075
Total Groove Offset: 0.274

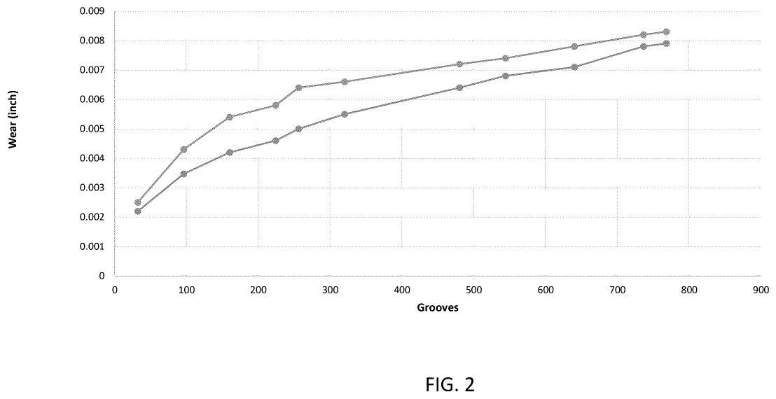

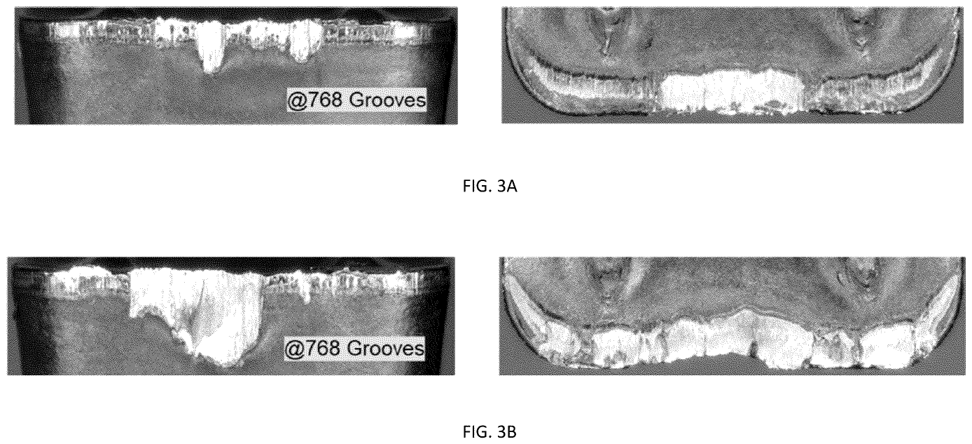

The results of the grooving testing are provided in FIG. 2 and FIGS. 3A and 3B. As provided in FIG. 2, Grooving insert #5 having a multilayer coating described herein exhibited substantially less wear than the Comparative Sample. The optical images of FIGS. 3A and 3B further illustrate the considerable performance advantages of Grooving insert #5 employing the multilayer coating described herein.

A grooving insert made in the same CVD heat as grooving insert #5 was tested for MT-TiCN hardness and modulus. Similarly a grooving insert made in the same heat as the Comparative Sample was tested for MT-TiCN hardness and modulus. The results are provided in Table VIII.

TABLE VIII
MT-TiCN Hardness and Modulus

| | MT-TiCN | MT-TiCN | |
|---|---|---|---|
| Sample | Hardness (H) | Modulus (E) | H/E |
| Insert #5 | 25 GPa | 519 | 0.0482 |
| Comparative Sample | 21.6 GPa | 505.7 | 0.0427 |

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A coated cutting tool comprising:
a substrate; and
a multilayered coating adhered to the substrate comprising:
a layer of medium temperature (MT) TiCN deposited by chemical vapor deposition (CVD), wherein the MT-TiCN layer comprises columnar grains having inclinations of 0° to 10° between a normal line of a (112) crystal plane and a normal line to the substrate occupying at least 35 area percent of a polished cross-sectional area of the MT-TiCN layer as determined by EBSD; and
a layer of α-Al₂O₃ deposited by CVD over the MT-TiCN layer, the α-Al₂O₃ layer comprising columnar grains having inclinations of 0° to 10° between a normal line of a (0001) crystal plane and a normal line to the substrate of occupying 35-65 percent area of a polished cross-sectional area of the α-Al₂O₃ layer as determined by EBSD.

2. The coated cutting tool of claim 1, wherein the columnar grains of the TiCN layer having inclinations of 0° to 10° occupy 40-60 percent of the polished cross-sectional area.

3. The coated cutting tool of claim 1, wherein the MT-TiCN layer has a hardness (H) to modulus (E) ratio of 0.043-0.05.

4. The coated cutting tool of claim 3, wherein the MT-TiCN layer has a texture coefficient (TC) of 2.5-3.5 for the (311) growth direction, the TC(311) being defined as:
$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$
where
I(hkl)=measured intensity of the (hkl) reflection;
Iₒ(hkl)=standard intensity of the (hkl) reflection according to International Center for Diffraction Data (ICDD) card 43-1484;
n=number of reflections (7) used in the TC calculation
(hkl) reflections used in the TC calculation are (111) (200) (220) (311) (331) (420) (422).

5. The coated cutting tool of claim 4, wherein the α-Al₂O₃ layer has texture coefficients greater than 7 for the (006) growth direction and greater than 5 for the (0 0 12) growth direction, the texture coefficients being defined as:
$$T C ( h k l ) = \frac{I ( hkl )}{{I}_{o} ( h k l )} {\{ \frac{1}{n} \sum \frac{I ( hkl )}{{I}_{o} ( h k l )} \}}^{- 1}$$
where
I(hkl)=measured intensity of the (hkl) reflection
Iₒ(hkl)=standard intensity of the (hkl) reflection according to International Center for
Diffraction Data (ICDD) card 43-1484
n=number of reflections (7) used in the TC calculation
(hkl) reflections used in the TC calculation are:
(012), (104), (110), (006), (113), (202), (024) and (116) to calculate TC(006); and
(012), (104), (110), (113), (116), (300), (214) and (0 0 12) to calculate TC(0012).

6. The coating cutting tool of claim 5, wherein the TC is from 6.5-7.8 for the (006) growth direction.

7. The coated cutting tool of claim 6, wherein the TC is from 5.2-6.7 for the (0 0 12) growth direction.

8. The coated cutting tool of claim 1, wherein the MT-TiCN layer has a length of 23 type of grain boundaries as measured using EBSD more 20% and less than 40% of the total length of all grain boundaries.

9. The coated cutting tool of claim 8, wherein the 23 type of grain boundaries are 25-35% of the total length of all grain boundaries.

10. The coated cutting tool of claim 1, wherein the MT-TiCN layer has a hardness of 24-30 GPa.

11. The coated cutting tool of claim 1, wherein the MT-TiCN layer has a modulus of 510-530 GPa.

12. The coated cutting tool of claim 1, wherein the MT-TiCN layer has a thickness of 2 μm to 20 μm.

13. The coated cutting tool of claim 1, wherein the α-Al₂O₃ layer has a thickness of 1 μm to 6 μm.

14. The coated cutting tool of claim 1, wherein the α-Al₂O₃ layer has a thickness of 1.5 μm to 4 μm.

15. The coated cutting tool of claim 1, wherein the columnar grains of the α-Al₂O₃ layer have an average grain width of 0.1 μm to 3 μm.

16. The coated cutting tool of claim 1, wherein the α-Al₂O₃ layer has a residual stress of 20-400 MPa.

17. The coated cutting tool of claim 1, wherein the substrate comprises cemented carbide comprising metallic binder in an amount of 1-15 weight percent.

18. The coated cutting tool of claim 1 further comprising a TiOCN layer arranged between the MT-TiCN layer and the α-Al₂O₃ layer.

19. A method comprising:
providing a substrate;
depositing a layer of medium temperature (MT) TiCN deposited by chemical vapor deposition (CVD) over the substrate, wherein the MT-TiCN layer comprises columnar grains having inclinations of 0° to 10° between a normal line of a (112) crystal plane and a normal line to the substrate occupying at least 35 area percent of a polished cross-sectional area of the MT-TiCN layer as determined by EBSD; and
depositing a layer of α-Al₂O₃ by CVD over the MT-TiCN layer, the α-Al₂O₃ layer comprising columnar grains having inclinations of 0° to 10° between a normal line of a (0001) crystal plane and a normal line to the substrate occupying 35-65 percent area of a polished cross-sectional area of the α-Al₂O₃ layer as determined by EBSD.

20. The method of claim 19, wherein the α-Al₂O₃ is nucleated on a TiOCN layer adjacent to the MT-TiCN layer.
